(19) United States
(12) Patent Application Publication
(10) Pub. No.: US 2007/0030149 A1
(43) Pub. Date: Feb. 8, 2007

(54) Theft deterrence system for a portable computer and method

(75) Inventor: Brian J. Hoerner, Spokane, WA (US)

Correspondence Address: WELLS ST. JOHN P.S., 601 W. FIRST AVENUE, SUITE 1300, SPOKANE, WA, 99201, US

(73) Assignee: Itronix Corporation

(21) Appl. No.: 11/197,878

(22) Filed: Aug. 5, 2005

(51) Int. Cl. G08B 13/14

(52) U.S. Cl. 340/571

(57) ABSTRACT

A theft deterrence system is provided for a portable computer. The system includes a portable computer, a theft. deterrence label, a sensor, and circuitry. The theft deterrence label is provided on the portable computer at a visually perceptible location and has indicia that visually alert a reader to deter theft of the computer. The sensor is carried by the portable computer and is configured to enable detection of removal of the label from the portable computer. The circuitry communicates with the sensor and is configured to receive an alert signal from the sensor responsive to removal of the label from the portable computer. The circuitry also disables a functionality component of the computer responsive to the alert signal. A method is also provided.

### TECHNICAL FIELD

This invention pertains to portable electronic devices. More particularly, the present invention relates to theft deterrence systems for portable electronic devices such as portable computers.

### BACKGROUND OF THE INVENTION

Systems have been provided for deterring the theft of portable computers. Attempts have been made to incorporate physical tethers, such as locking cable systems, onto portable computers. Typically, the portable computer is affixed with a flexible cable to a large object, such as a piece of large furniture. However, this technique does not work when the portable computer is being transported, and the theft occurs while the portable computer is being transported. This is a particular problem with laptop, pen, and tablet computers.

Other attempts have been made to incorporate electronic tethers, such as those disclosed in U.S. Pat. Nos. 5,910,768 and 6,072,393. However, these systems do not work when an article is not tethered, such as when the article is being transported beyond a local operating environment.

Accordingly, improvements are needed to enable theft deterrence for portable electronic devices, such as portable computers in a manner that visually deters a potential thief and disables operation of the device when the thief physically alters the device to remove the visual deterrence on the device. Such improvements are particularly needed for devices that are used in normal operating environments where physical or electronic tethers are impractical due to mobility requirements during use.

### SUMMARY OF THE INVENTION

A visually or physically perceptible deterrence feature is provided on a portable electronic device, such as a portable computer along with a component that disables the device when the perceptible deterrence feature is removed from the device. In one case, the device is a laptop or tablet computer, and a visually perceptible warning sticker is applied to a visible surface of the computer. In such case, the warning sticker includes indicia, such as text, that warns the user that the computer incorporates an anti-theft remote disabling device, and further identifies ownership of the computer. Completely unapparent to the user, a detection system is provided in the computer that detects removal of the sticker, and which initiates a seemingly unrelated disablement of the computer in response to a user removing the sticker from the computer. Such a system helps address a problem of portable computer theft, particular those stolen by employees.

According to one aspect, a theft deterrence system is provided for a portable computer. The system includes a portable computer, a theft deterrence label, a sensor, and circuitry. The theft deterrence label is provided on the portable computer at a visually perceptible location and has indicia that visually alert a reader to deter theft of the computer. The sensor is carried by the portable computer and is configured to enable detection of removal of the label from the portable computer. The circuitry communicates with the sensor and is configured to receive an alert signal from the sensor responsive to removal of the label from the portable computer. The circuitry also disables a functionality component of the computer responsive to the alert signal.

According to another aspect, a mechanism is provided for deterring theft of a portable electronic device. The mechanism includes a portable electronic device, a theft deterrence label, detection circuitry, and disabling circuitry such as software that is implemented via memory and processing circuitry. The theft deterrence label is provided on the device and has indicia that visually alert a reader to deter theft of the device. The detection circuitry is configurable to detect removal of the label from the portable electronic device. The disabling circuitry communicates with the detection circuitry and is configurable to disable a functional aspect of the device responsive to the detection circuitry detecting removal of the label.

According to yet another aspect, a method is provided for deterring theft of a portable computer. The method includes: providing a portable computer with a label on a visible outer surface having indicia that visually alert a reader to deter theft of the computer; detecting removal of the label from the computer; and responsive to detecting removal, disabling operation of a functioning aspect of the computer.

### BRIEF DESCRIPTION OF THE DRAWINGS

Preferred embodiments of the invention are described below with reference to the following accompanying drawings.

FIG. 1 is a perspective view of a rugged laptop computer in a partially open configuration and having a theft deterrence sticker provided on a top face of the computer and a system disabling component integrated into the computer, according to one aspect of the present invention.

FIG. 2 is an elevational view of the laptop computer of FIG. 1 illustrating placement of the theft deterrence sticker in a visually perceptible location on the computer.

FIG. 3 is a simplified block diagram illustrating system disabling components that are integrated into the computer of FIGS. 1-2.

FIG. 4 is an enlarged partial view of the computer of FIG. 2 illustrating visually perceptible indicia provided by the theft sticker affixed onto a visually perceptible location of the computer.

FIG. 5 is a view corresponding with that depicted in FIG. 4 of a first alternative construction for a theft sticker.

FIG. 6 is a view corresponding with that depicted in FIG. 4 of a second alternative construction for a theft sticker.

FIG. 7 is a simplified, bottom perspective view of a next generation notebook computer having a third alternative construction for a theft sticker placed thereon.

FIG. 8 is a process flow diagram showing the logic processing for enabling a theft detection feature on a portable computer.

FIG. 9 is a process flow diagram showing the logic processing for detecting theft of a portable computer.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to several preferred embodiments of Applicant's invention for a theft deterrence and device disabling system for portable electronic devices. While the invention is described by way of several preferred embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

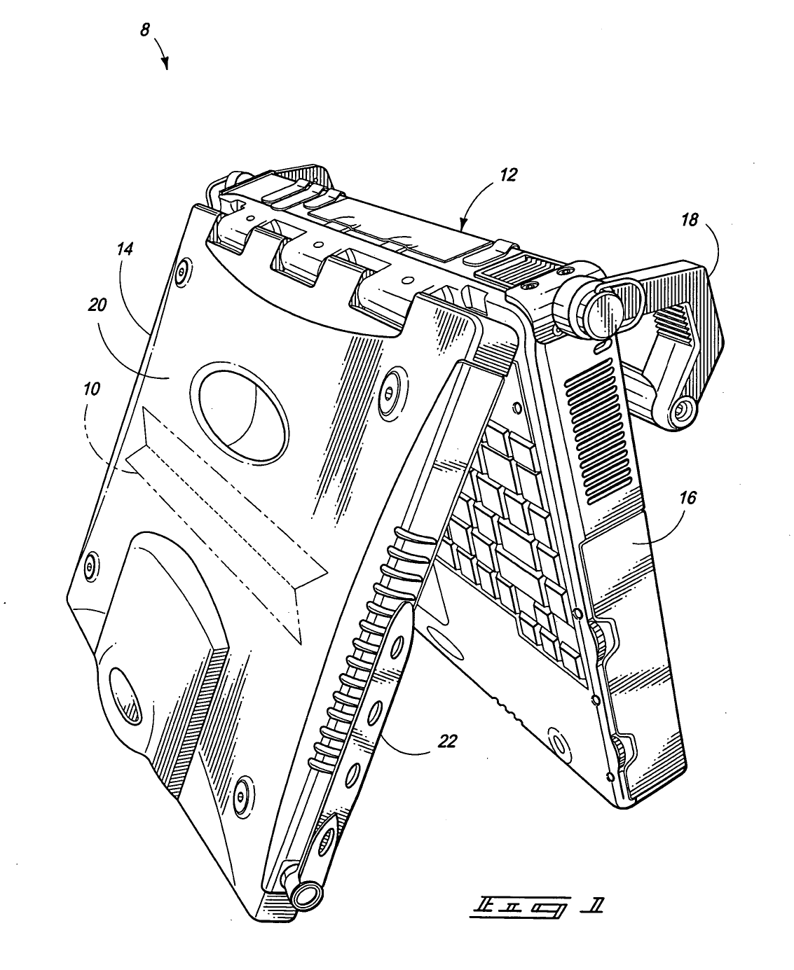

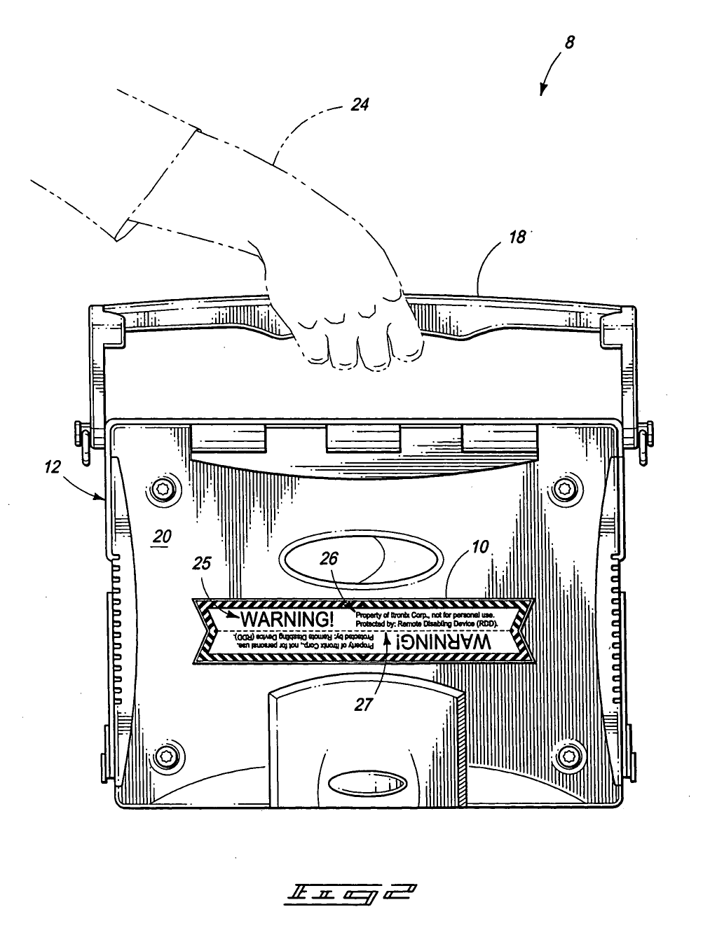

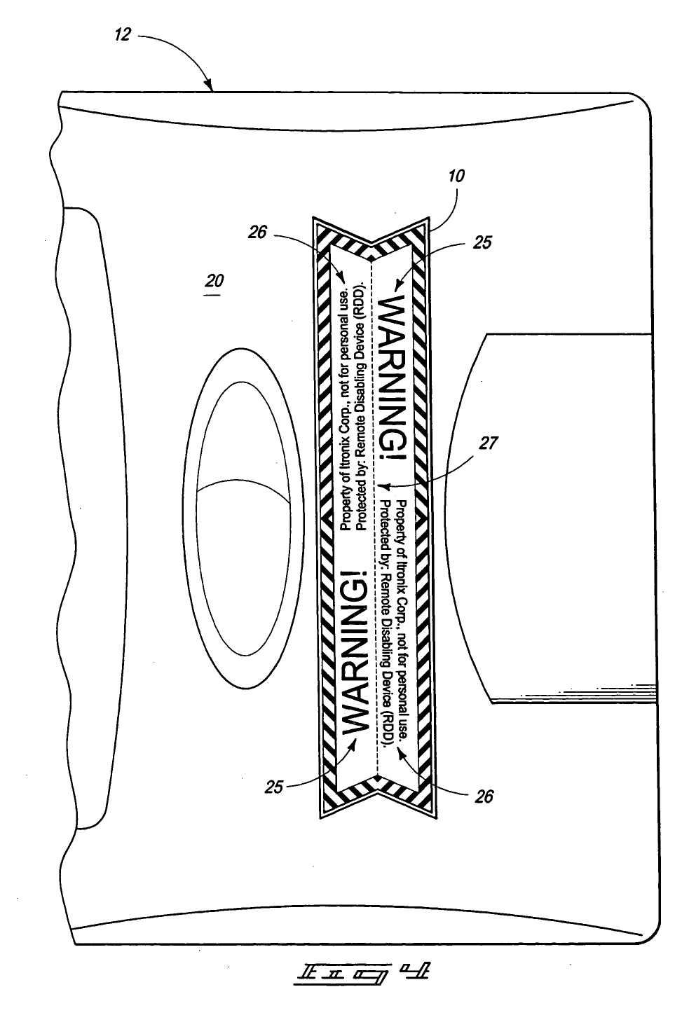

FIG. 1 illustrates a theft deterrence and disabling system 8 for a portable computer 12, such as a laptop computer, according to one aspect of the present invention. System 8 includes a label, or tag 10 that contains visually perceptible indicia, as depicted and described below in greater detail with reference to FIGS. 2 and 4. According to one construction, label 10 comprises a sticker that is applied onto computer 12 via an adhesive backing. System 8 includes computer system components within computer 12 that cooperate to disable operation of computer 12 in response to a user removing label 10 from computer 12.

As shown in FIG. 1, portable computer 12 is a laptop computer having a display case 14 and a keyboard case 16. However, it is envisioned that the features of this invention can be implemented on any portable electronic device, including laptop computers, tablet computers, pen computers, PDAs, meter reading devices, test instruments, mobile phones, or any other portable device having internal electronics.

According to one construction case 16 includes a carrying handle that facilitates mobile transport of computer 12 by users, such as service personnel and mobile workers. Likewise, display case 14 supports a wireless antenna 22 for rendering computer 12 capable of wireless communications. Also according to one implementation, label 10 is affixed onto an outer, or top surface 20 of display case 14 in a manner that makes label 10 visually perceptible to anyone whether computer 12 is in an open or closed configuration. However, it is understood that label 10 can be affixed onto any available surface of computer 12, whether viewable in an open configuration, closed configuration, or both configurations.

FIG. 2 shows a user 24 transporting portable computer 12 in a closed configuration via grasping handle 18. Label 10 is clearly visible to user 24, as well as third party individuals while computer 12 is in this closed configuration. More particularly, label 10 is presented on outer surface 20 so as to be highly visible under normal use and during transport of computer 12. Furthermore, label 10 includes various visually perceptible indicia 25-27 presented on a top surface. More particularly, visually perceptible indicia 25 comprises a “WARNING!” text message to a reader of the message. Visually perceptible indicia 26 comprise a “Property of (Owner), not for personal use” text message. Visually perceptible indicia 27 comprises a “Protected by: Remote Disabling Device (RDD)” text message.

As viewed by a reader of indicia on label 10, indicia 25 provides a general warning notice in relatively large, bold letters and on a visible surface of computer 12. Indicia 26 provide notice and identification of ownership of computer 12. Indicia 27 provides an intentionally misdescriptive notice of presence of a remote disabling security feature for computer 12 which is intended to deter theft of computer 12.

In such case, label 10 comprises a warning sticker that includes indicia, such as text, that warns the user that the computer incorporates an anti-theft remote disabling device, and further identifies ownership of the computer. Label 10 also includes bold and colorful graphic, non-text components that are visible to a viewer and that highlight the text for more visible and bold presentation. A detection system is provided in the computer that detects removal of the label, and which initiates a seemingly unrelated disablement of the computer in response to a user removing the label from the computer. Typically, a user who has stolen computer 12 will feel a need to remove label 10 due to the visible and bold presentation of indicia on label 10.

In one case, it is difficult for a user to notice presence of the detection system when a label is removed from a computer. For example, the sensor may use a relatively small aperture that communicates with an exterior of the computer to detect removal of the label. In another case, an electromagnetic sensor is provided inside the computer and the label includes a metal (or ferrous) component that is detected by the sensor so that removal of the label can be sensed. Such a system is completely unapparent to a user from the outside of the computer.

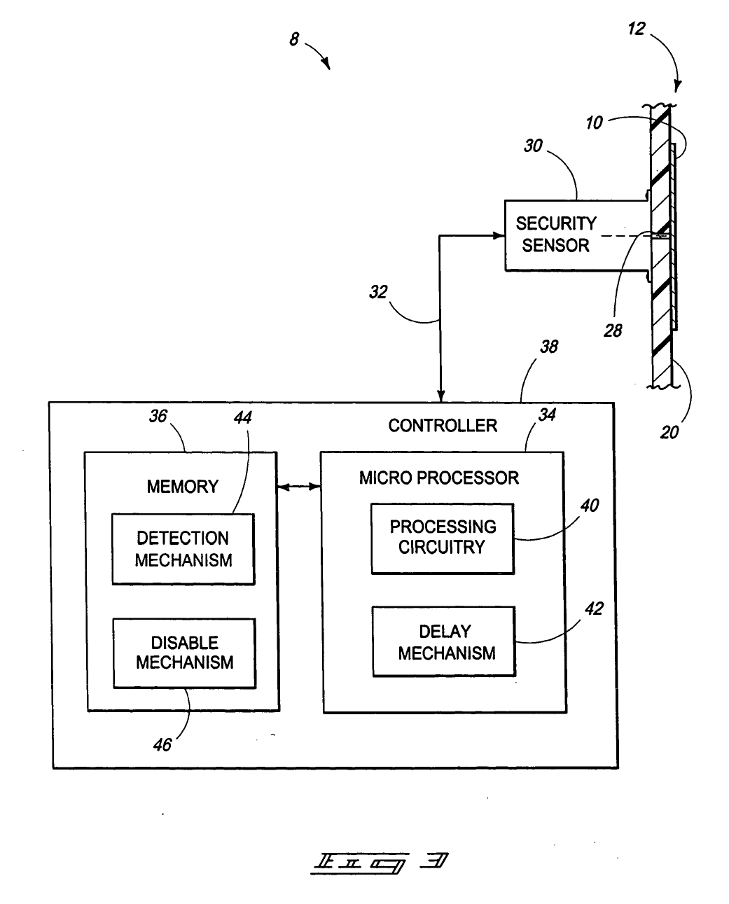

FIG. 3 shows one suitable implementation for theft deterrence and disabling system 8 of the present invention. More particularly, the removal of label 10 from outer surface 20 of computer 12 is detected using a security sensor 30 that is provided on computer 12. A controller within computer 34 provides circuitry via processing circuitry 40 of microprocessor 38 and circuitry of memory 36 that alerts and triggers system 8 to disable operation of computer 12 responsive to removal of label 10 from computer 12. Microprocessor 38 includes processing circuitry 40 and a clock timer 42. Alternatively, an algorithm such as a boot-up algorithm can be used that counts a number of boot-ups before triggering disablement of the computer or the computer hard disk drive. Sensor 30 sends a signal via a signal communication link 32, such as via electrical wires, to controller 34.

For the case of an algorithm, the algorithm can count the number of times that a computer has been booted up and decrement the count for each time the computer is booted up. In one case, the algorithm disables the computer or the computer hard disk drive after the occurrence of a finite, set number of boot-ups. Alternatively, the computer can select a random number of boot-ups, after which the algorithm will disable either the computer and/or the computer hard disk drive. As a further alternative construction, some other delay mechanism can be utilized in order to disassociate cause and effect when the label is removed and the computer stops operating normally so that a user cannot determine readily that removal of the sticker has caused disablement of the computer functionality. As a further alternative implementation, removal of the sticker could immediately cause the computer and/or the computer disk drive to be disabled.

According to one implementation, circuitry 40 is configured to disable operation of computer 12 in an apparently random manner, seemingly unrelated with removal of label 10 from computer 12. For example, controller 34 can be configured to disable operation of computer 12 after a random amount of time has transpired, or after which a random or fixed number of boot-ups have occurred for computer 12. One way is to use a random number generator, or an algorithm that generates a seemingly random period of time or number of computer boot-ups operations. However, it is understood that alternative implementations can be provided using circuits comprising solely analog components. Optionally, a mix of analog and digital components can be used. Further optionally, purely digital components can be used.

As shown in FIG. 3, according to one implementation microprocessor 38 is provided by a central microprocessor of computer 12. Likewise, memory 36 is provided by memory within computer 12, such as memory on a hard drive or semiconductor memory of computer 12. A detection mechanism 44 and a disable mechanism 46 are provided in memory 36 for respectively detecting a signal from sensor 30 indicating removal of label 10 and disabling operation of computer 12 responsive to detection of removal of label 10.

In one case, sensor 30 comprises an infrared light sensor that is rigidly affixed to an inside surface of case where it is optically sealed with a relatively small and unobtrusive optical port 28 that extends to outer surface 20. Label 10 is designed to be optically opaque in the infrared range which prohibits transmission of infrared light waves to sensor 30. Removal of label 10 causes sensor 30 to detect infrared light waves via port 28. To a user, port 28 appears to be a small inconspicuous aperture of unknown use. Port 28 may not appear to be part of a theft deterrence and disabling system, from a user perspective. The port is made small to reduce the likelihood that it will be noticed, and that a user will be able to ascertain its purpose. In one case, the aperture could be disguised to look like a microphone port. Hence, a user that removes label 10 from computer 12 will not associate the removal with eventual disablement of computer 12.

Optionally, sensor 30 can be constructed using any of a number of alternative physical techniques to detect removal of label 10 from computer 12. For example, sensor 30 can be a visible light sensor coupled with an optical port, a magnetic sensor (with label 10 having a magnetic or metal component), an electronic sensor, an acoustic sensor, a coupling capacitive sensor, or an adhesive sensor that detects movement or removal of label 10. For example, removal of a particular label can cause a change in capacitance that is detectable using a capacitive sensor. In some cases, a port may not be necessary. For example, a magnetic sensor can be configured to detect removal of a ferrous label provided on an outer surface of a plastic housing, where the sensor is provided inside of the housing.

Disablement of computer 12 can vary in form. In one case, computer 12 can be rendered completely inoperative to a normal user, requiring a computer technician to reinitiate operation of the computer. In another case, computer 12 can be rendered with limited operability to a user. For example, system BIOS for the computer 12 may prevent boot-up of the computer 12 or access to the hard disk drive and instead display a visual prompt on a display screen of the computer, such as, “This system is not functional. If this unit has been lost or stolen, please return for possible reward.” In another case, system BIOS for computer 12 will prevent access to the hard disk drive (HDD), thereby locking up access to the hard disk drive, but still allowing boot-up of a floppy disk that will enable a technician to fix operation of the computer when a sticker has been inadvertently removed, or where a stolen computer has been later recovered and the technician wants to re-enable operation of the computer.

In operation, sensor 30 alerts controller 34 of system 8 that label 10 has been removed from computer 12. Once system 8 is alerted, a random amount of time or a random number of boot-ups (of a fixed number of boot-ups) are allowed to pass before computer 12 is disabled by a disabling event. From a user's perspective, system 8 appears to associate the disabling event with some sort of “Remote Disabling Device (RDD)” as identified by indicia 27 of FIG. 2, which is implied by wording of the textual message on label 10. However, computer 12 does not have a remote disabling device, which would add significantly to the overall cost and complexity, thereby saving money and reducing complexity. However, an optional implementation enables computer 12 to be configured to send a message via a radio signal or network communication, such as a LAN communication or WAN communication, in order to indicate that the computer is stolen to a service maintainer or owner over a network.

According to an alternative radio or network communication implementation, a radio frequency can be generated and sent by the computer to send a notice to a home base where maintainer personnel can identify that the computer has been stolen and disabled. Optionally, if the computer 12 includes a GPS system, the RF radio frequency signal can tell the maintainer at the home base the location of computer 12 to assist in recovery of the computer. As a further alternative implementation, where a computer 12 is also configured with Internet access, computer 12 can be triggered to send a hidden message to a selected IP address associated with the home base when the computer is hooked up to the Internet by a user who has stolen the computer.

In one case, controller 34 generates an input/output (I/O) bit indicative of removal of the label. This bit is used to trigger system 8 to initiate disablement of some or all of the operating aspects of computer 12. Furthermore, after a thief removes the sticker, there is no indication that the removal could have triggered something in the system that caused the disablement. In other words, the action is invisible to the person who has removed the label. According to one construction, re-attachment of the sticker does not necessarily reverse the process and enable the computer. However, such re-attachment might not disable operation of the computer for the case where the computer was not turned on when the sticker was removed, and the sticker was re-attached before the computer was ever turned on.

FIG. 4 shows one configuration for label 10 corresponding with that depicted in the embodiment of FIGS. 1 and 2. More particularly, label 10 is designed to be as large as possible and is appropriate to achieve a desired purpose within the physical confines of a flat region in outer surface 20 of computer 12. Label 10 is relatively large in order to make the indicia more readily noticeable to users, as well as third party individuals that might see label 10. Label 10 is also constructed of highly visible colors, such as black text placed on a fluorescent yellow background color, according to one construction, to enhance visual perception of the indicia. Accordingly, the text is also made as large as is practically possible so that it is possibly visible from several feet away. Additionally, indicia 25 incorporate usage of especially large text to capture a reader's immediate attention and draw them in to read the text of remaining indicia 26-27.

Additionally, label 10 is constructed from a material that is resistant to accepting adhesion of another label, tape, or marker ink over label 10 in order to cover up the indicia 25-27. For example, label 10 can be constructed with a top layer having a silicon surface that resists adherence of adhesives on labels and tape, and further resists acceptance of inks from markers. Another coating comprises a Teflon® surface. Yet other surfaces and materials are contemplated. Optionally, label 10 can be constructed from adhesive-backed paper, vinyl, Mylar®, aluminum, or any other material used to construct labels, tags, or stickers and which is capable of being removed or obliterated by a user that wants to hide or redact the indicia from the computer.

Preferably, the sticker utilizes an adhesive material that removes cleanly over the area in which a sensor is provided so that removal of the sticker can be cleanly detected. According to an alternative construction, the sticker includes magnetic or ferrous material, and the sensor is an electromagnetic sensor that detects removal of the magnetic material through a plastic component of the housing which makes presence of a sensor completely undetectable from an exterior of the computer.

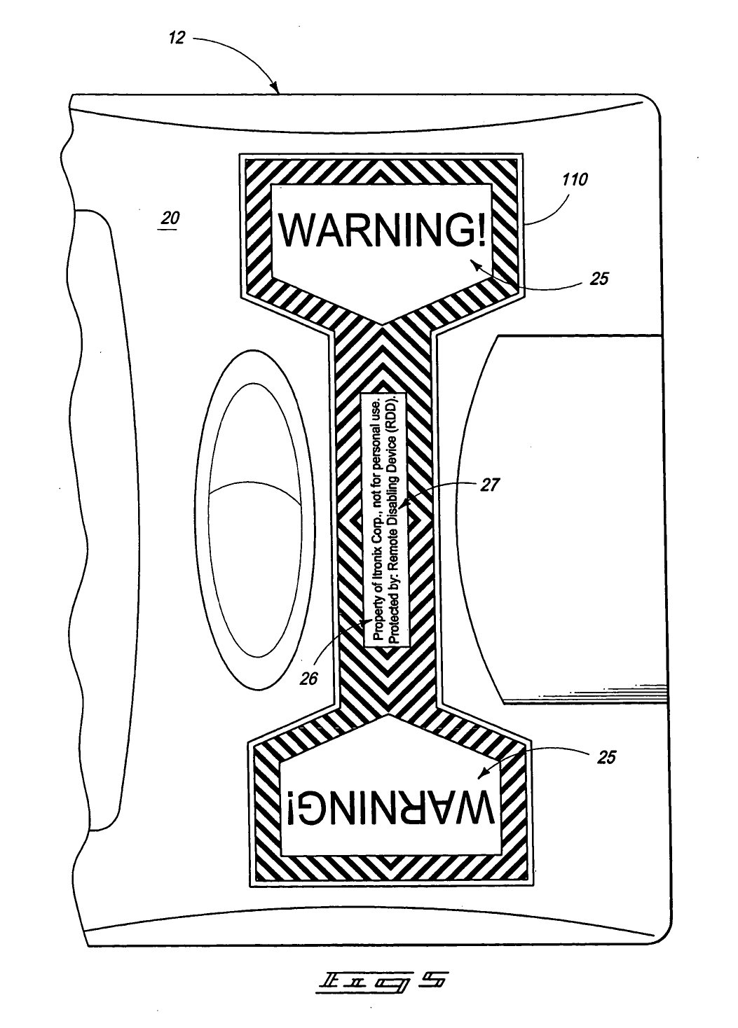

FIG. 5 shows an alternative configuration for a label 110 over that depicted by label 10 of FIGS. 1-5. Label 110 includes indicia 25-27 placed in a different configuration over that provided on label 10.

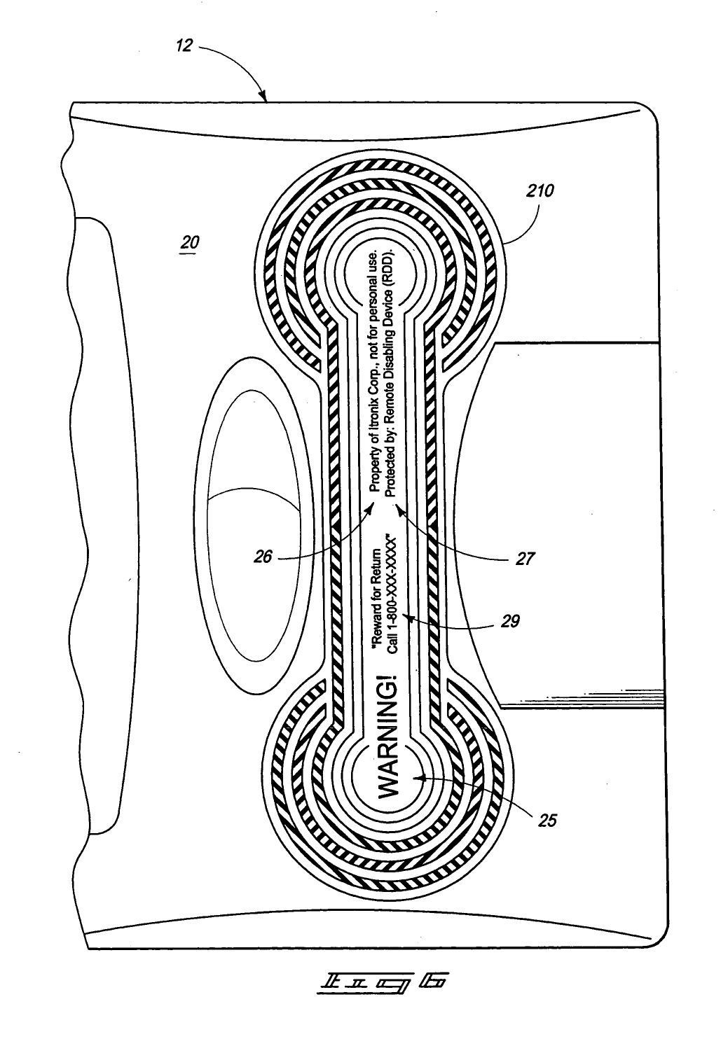

FIG. 6 shows a second alternative configuration for a label 210 over that depicted by label 10 of FIGS. 1-5 and label 110 of FIG. 5. Indicia 25-27 are placed in yet a different configuration over that provided on labels 10 and 110. Indicia 25-27 are essentially the same as indicia 25-27 of labels 10 and 110 of FIGS. 4 and 5, respectively. However, indicia 29 comprise an offer for a reward in the event a person has acquired the portable computer 12 and they return the computer in response to reading the offer for a reward. More particularly, indicia 29 states “Reward for Return Call 1-800-XXX-XXXX”, where “X” indicates a numerical value for a specific telephone number for an owner of the portable computer of a service provided that provides services to retrieve stolen or misplaced computers.

The embodiments depicted in FIGS. 1-6 enable a method of deterring theft of a portable computer. The method includes providing a portable computer with a label on a visible outer surface having indicia that visually alert a reader to deter theft of the computer. The method also includes detecting removal of the label from the computer. The method further includes, responsive to detecting removal, disabling operation of a functioning aspect of the computer. The same method can also be applied to any portable electronic device.

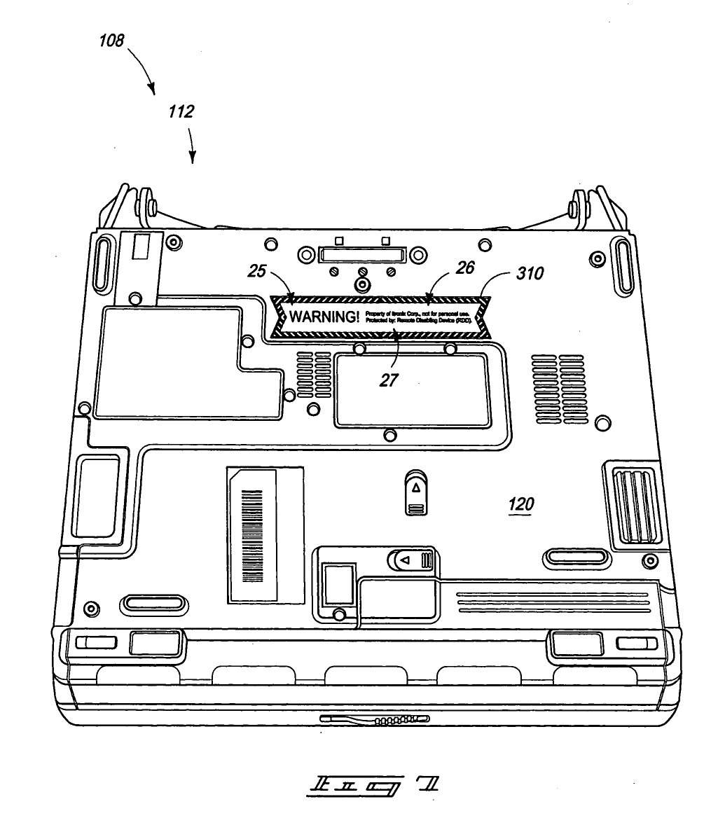

FIG. 7 illustrates a third embodiment label 310 provided on a bottom surface 120 of an alternatively constructed notebook computer 112 that is provided as part of a theft deterrence and disabling system 108. System 108 is similar to system 8 of FIGS. 1-6.

Label 310 includes visually perceptible indicia 25-27 (or indicium) which are the same as indicia 25-27 of FIG. 2. According to such construction, label 310 is adhesively applied on top of an aperture, or port (not shown), in a manner similar to that depicted in FIG. 3. According to one construction, a sensor communicates with the port, or is provided within the port, for detecting removal of label 310 from surface 120. According to one construction, the sensor comprises a Texas Advanced Optoelectronic Solutions (TAOS) light-to-voltage converter, Model No. TSL 13T, available from TAOS Inc. U.S.A., 800 North Jupiter Road, Suite 205, Piano, Tex. 75074. Alternatively, other forms of sensors can be utilized, such as optical sensors, tactile sensors, electromagnetic sensors, or any other sensor capable of detecting removal of a label or sticker from the housing of a portable computer.

Although label 310 is shown adhesively affixed onto bottom surface 120, it is understood that label 310 could optionally be affixed onto any visible surface of computer 112 including side surfaces, end surfaces, top surfaces, bottoms surfaces, and even the keyboard surface and the display surface. Even furthermore

label 310 could even be affixed onto a handle of the computer, with wires being routed through the handle to the sensor, and with the sensor provided inside of the handle.

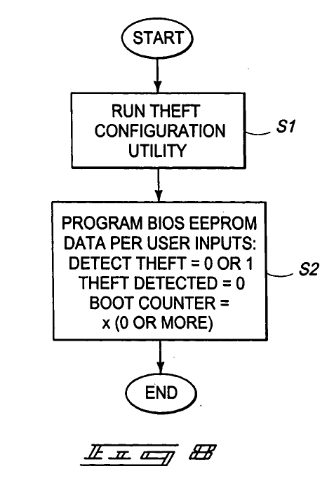

FIG. 8 is a logic flow diagram illustrating the steps implemented via processing circuitry of a central processing unit for a portable computer in order to enable configuration and set-up for a theft deterrence and disabling system of the present invention. According to the steps in FIGS. 8, a system administrator (or maintenance personnel) for a company runs a configuration utility to enable set-up and initiation for the theft deterrence and disabling system by starting the steps of the logic flow diagram. After starting the process flow, the process proceeds to Step

In Step “S1”, the system administrator runs a theft configuration utility that enables configuration of the computer to detect removal of the sticker via a sensor. After performing Step “S1”, the process proceeds to Step “S2”.

In Step “S2”, a system administrator programs BIOS EPROM data with user-desired inputs that define how a portable computer will be disabled in response to detected theft of the computer. More particularly, a value is assigned by the system administrator for “DETECT THEFT” equal to 0 or 1. A value is also assigned to “THEFT DETECTED” equal to 0. A value is assigned to “BOOT COUNTER” equal to X, where X is the value of 0 or greater. After performing Step “S3”, process proceeds to “end” and is terminated. Accordingly, the process for enabling the theft deterrence and disabling system of a portable computer via a system administrator or a maintainer is completed.

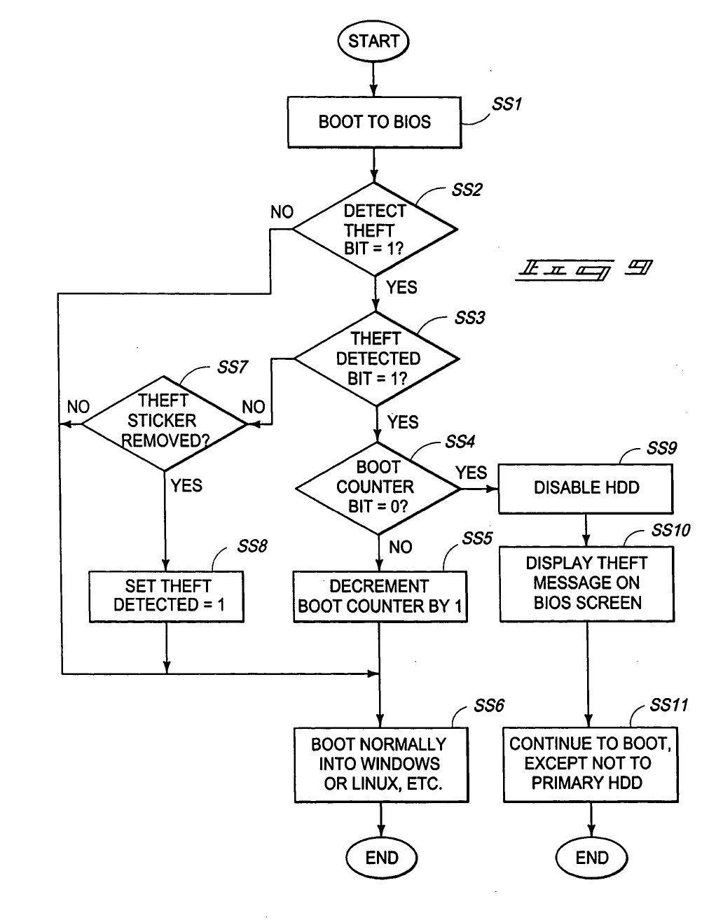

FIG. 9 illustrates the steps involved in implementing a method for detecting theft of a portable computer via the theft deterrence and disabling system of FIGS. 1-7. More particularly, the logic flow diagram illustrates the steps in implementing a portable computer theft detection and component/computer disablement feature for a portable computer. An individual who has misappropriated a portable computer starts the process at “start”. After starting the process, the process proceeds to Step “SS1”.

In Step “SS1”, a user has acquired the portable computer and has turned on the computer to initiate a boot to bios which initiates boot-up of the computer and loading of the operating system and related operating programs. After performing Step “SS1”, the process proceeds to Step “SS2”.

In Step “SS2”, the system queries whether or not the sensor and processing circuitry have detected theft of a label from the portable computer comprising determining whether a bit value of 1 has been assigned to “DETECT THEFT”. If the system has detected theft by detecting a bit value of 1, the process proceeds to Step “SS3”. If not, the process proceeds to Step “SS6”.

In Step “SS3”, the system queries whether an assigned “THEFT DETECTED” bit equals. a value of 1. If it does, the process proceeds to Step “SS4”. If not, the process proceeds to Step “SS7”.

In Step “SS4”, the system queries whether the “BOOT COUNTER” has a bit value equal to 0. If the value is 0, the process proceeds to Step “SS9”. If not, the process proceeds to Step “SS5”.

In Step “SS5”, the system decrements “BOOT COUNTER” by a value of 1. After performing Step “SS5”, the process proceeds to Step “SS6”.

In Step “SS6”, the system boots up the personal computer into Windows or some other operating system, such as Linux, etc. and enables operation of associated computer components, such as a hard disk drive (HDD). After performing Step “SS6”, the process terminates.

In Step “SS7”, the system queries whether the theft sticker has been removed. If the theft sticker has been removed, the process proceeds to Step “SS8”. If not, the process proceeds to Step “SS6”.

In Step “SS8”, the system sets the “THEFT DETECTED” bit value equal to 1. After performing Step “SS8”, the process proceeds to Step “SS6”.

In Step “SS9”, the system disables operation of the hard disk drive (HDD). Optionally, the system can disable another operating component of the computer, or can completely disable operation of the computer. After performing Step “SS9”, the process proceeds to Step “SS10”.

In Step “SS10”, the process initiates display of a theft message on the BIOS screen indicating to a user that the computer has been determined to be stolen. After performing Step “SS10”, the process proceeds to Step “SS11”.

In Step “SS11”, the process continues to boot-up the computer, except for not enabling operation of the hard disk drive (HDD). After performing Step “SS11”, the process is terminated.

Although the above system and method triggers disablement of a hard disk drive (HDD) of a portable computer after a preset number of boot-ups have occurred subsequent to a label being removed, other criteria can be used. For example, the computer can be immediately disabled after the sticker has been removed (and detected). Further optionally, a random number of boot-ups can be used to time the disablement. Even further optionally, a set amount of time (using a processor clock) can be used to trigger the disablement (of the computer or a computer component). As an even further option, in some cases no message is displayed to a user indicating that the computer has now been rendered non-functional. Instead, the computer (or the computer hard disk drive) just stops working. Even furthermore, it is understood that the method steps of this invention can be implemented in hardware, software, and/or firmware.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A theft deterrence system for a portable computer, comprising:
a portable computer;
a theft deterrence label provided on the portable computer at a visually perceptible location and having indicia that visually alert a reader to deter theft of the computer;
a sensor carried by the portable computer and configured to enable detection of removal of the label from the portable computer; and
circuitry communicating with the sensor and configured to receive an alert signal from the sensor responsive to removal of the label from the portable computer and disable a functionality component of the computer responsive to the alert signal.

2. The theft deterrence system of claim 1 wherein the circuitry is provided by processing circuitry of a microprocessor.

3. The theft deterrence system of claim 1 wherein the circuitry is provided by a control system of the computer.

4. The theft deterrence system of claim 1 wherein the circuitry delays disablement of the functionality component of the computer relative to receipt of the alert signal.

5. The theft deterrence system of claim 4 wherein the circuit delays disablement until after occurrence of a number of boot-ups of the computer.

6. The theft deterrence system of claim 4 wherein the circuit delays disablement after a period of time has elapsed since receipt of the alert signal.

7. The theft deterrence system of claim 1 wherein the indicia on the label identify a party with a property interest in the portable computer.

8. The theft deterrence system of claim 1 wherein the indicia on the label identify a misdescriptive mechanism for disabling the portable computer.

9. The theft deterrence system of claim 1 wherein the label comprises a surface that is resistant to bonding with an adhesive or a marking agent.

10. The theft deterrence system of claim 9 wherein the top surface comprises silicon.

11. The theft deterrence system of claim 1 wherein the circuitry is configured to disable boot-up of an operating system of the computer.

12. The theft deterrence system of claim 1 wherein the circuitry is configured to display a text message to a user that the computer is non-functional.

13. The theft deterrence system of claim 12 wherein the circuitry is further configured to display a reward offer for return of the computer to a listed owner of the computer.

14. A mechanism for deterring theft of a portable electronic device, comprising:
a portable electronic device;
a theft deterrence label provided on the device and having indicia that visually alert a reader to deter theft of the device;
detection circuitry configurable to detect removal of the label from the portable electronic device; and
disabling circuitry communicating with the detection circuitry and configurable to disable a functional aspect of the device responsive to the detection circuitry detecting removal of the label.

15. The mechanism of claim 14 wherein the label comprises a text message configured to deter theft of the portable electronic device.

16. The mechanism of claim 15 wherein the text message comprises a warning configured to visually alert a reader to presence of the text message.

17. The mechanism of claim 15 wherein the text message comprises identification information configured to identify an owner of the portable electronic device.

18. The mechanism of claim 15 wherein the portable electronic device is a portable computer.

19. The mechanism of claim 14 wherein the detection circuitry is provided at least in part by a sensor configured to detect presence of the label on the device.

20. The mechanism of claim 19 wherein the sensor is an infrared sensor mounted within the device, and the device further comprises an optical port aligned with the sensor, wherein the label is adhered over the optical port, and the port is configured to guide infrared light waves to the infrared sensor for detection when the label is removed from over the optical port.

21. The mechanism of claim 14 wherein the portable electronic device comprises processing circuitry and the disabling circuitry is provided at least in part by the processing circuitry.

22. The mechanism of claim 14 wherein the label comprises a top surface that inhibits adhesion with adhesives.

23. A method of deterring theft of a portable computer, comprising:
providing a portable computer with a label on a visible outer surface having indicia that visually alert a reader to deter theft of the computer;
detecting removal of the label from the computer; and
responsive to detecting removal, disabling operation of a functioning aspect of the computer.

24. The method of claim 23 wherein the computer includes a sensor configured to detect removal of the label from the computer.

25. The method of claim 23 wherein the computer includes processing circuitry configured to disable a functioning aspect of the computer responsive to detecting removal of the label.

26. The method of claim 23 wherein the indicia comprises at least one of: a warning, an ownership identification, and an assertion of presence of a remote disabling device.

27. The method of claim 23 further comprising providing an optical port extending from an outer surface of the computer to an optical sensor within the computer and adhering the label over the optical port, and wherein detecting comprises optically detecting light transmission through the optical port responsive to removal of the label from the computer.

28. The method of claim 27 wherein the sensor comprises an infrared sensor configured to detect infrared light waves through the optical port.

29. The method of claim 23 wherein disabling comprises disabling boot-up of an operating system of the computer.

30. The method of claim 23 following disabling, further comprising displaying a message to a user identifying disablement of the function aspect of the computer.

31. The method of claim 30 further comprising displaying a message to a user identifying a reward offer for return of the computer if the computer has been lost or stolen.
